(19) United States
(12) Patent Application Publication
(10) Pub. No.: US 2023/0307163 A1
(43) Pub. Date: Sep. 28, 2023

(54) MULTILAYER COIL COMPONENT AND METHOD FOR ADJUSTING CHARACTERISTICS OF MULTILAYER COIL COMPONENT

(71) Applicant: TDK Corporation, Tokyo (JP)

(72) Inventors: Munehiro TAKAKU, Tokyo (JP); Nobuyuki OKUZAWA, Tokyo (JP); Kazuya TOBITA, Tokyo (JP); Teruhiro MITSUYASU, Tokyo (JP)

(73) Assignee: TDK Corporation, Tokyo (JP)

(21) Appl. No.: 18/166,071

(22) Filed: Feb. 8, 2023

(30) Foreign Application Priority Data
Mar. 25, 2022 (JP) 2022-050267

(51) Int. Cl. H01F 5/04; H01F 27/29; H01F 27/28; H01F 41/10

(52) U.S. Cl. CPC H01F 5/04; H01F 27/292; H01F 27/2804; H01F 41/10

(57) ABSTRACT

A multilayer coil component 1 includes an element body, a first terminal electrode, a second terminal electrode, a coil, a first connecting conductor, and a second connecting conductor, the coil includes first wiring portions, second wiring portions, and pillar portions, and lengths of the pillar portions in a first direction are longer than lengths of the pillar portions in a third direction.

### TECHNICAL FIELD

The present disclosure relates to a multilayer coil component and a method for adjusting characteristics of a multilayer coil component.

### BACKGROUND

As a conventional multilayer coil component, for example, a multilayer coil component described in Patent Document 1 (Japanese Unexamined Patent Publication No. 2017-216428) is known. The multilayer coil component described in Patent Document 1 includes an insulator portion that has a width direction in a first axis direction, a length direction in a second axis direction, and a height direction in a third axis direction, and is made of a non-magnetic material, and a coil portion that has a winding portion wound around the first axis direction and disposed inside the insulator portion, in which a ratio of a height dimension to a length dimension of the insulator portion is at least 1.5 times a ratio of a height dimension between inner circumferential portions of the winding portion in the third axis direction to a length dimension between inner circumferential portions of the winding portion in the second axis direction.

### SUMMARY

In a multilayer coil component, when a magnetic path length of a coil is changed, its inductance value also changes. In a multilayer coil component, the magnetic path length of the coil and the inductance value are inversely proportional, with the inductance value decreasing when the magnetic path length of the coil is lengthened and the inductance value increasing when the magnetic path length of the coil is shortened. In a multilayer coil component, when the magnetic path length of the coil is lengthened in order to reduce the inductance value, its resistance value increases and thus its Q factor decreases. When the inductance value is adjusted as described above due to the magnetic path length of the coil, the Q factor also changes, and thus it may not be possible to obtain desired characteristics of a multilayer coil component by adjusting the inductance value by the magnetic path length of the coil.

An object of one aspect of the present disclosure is to provide a multilayer coil component in which desired characteristics can be obtained and a method for adjusting characteristics of a multilayer coil component.

A multilayer coil component according to one aspect of the present disclosure includes: an element body that includes a pair of end surfaces opposite each other in a first direction, a mounting surface and a main surface opposite each other in a second direction, and a pair of side surfaces opposite each other in a third direction; a pair of terminal electrodes disposed on the element body; a coil that is disposed in the element body, is electrically connected to the pair of terminal electrodes, and has a coil axis extending in the third direction; and connecting conductors connecting each of one end portion and another end portion of the coil to one of the pair of terminal electrodes, wherein the coil includes first wiring portions disposed on the main surface side, second wiring portions disposed on the mounting surface side, and connecting portions that extend in the second direction and connect the first wiring portions to the second wiring portions, and lengths of the connecting portions in the first direction are longer than lengths of the connecting portions in the third direction, and/or lengths of the first wiring portions and the second wiring portions in the second direction are longer than lengths of the first wiring portions and the second wiring portions in the third direction.

In the multilayer coil component according to one aspect of the present disclosure, the lengths of the connecting portions in the first direction are longer than the lengths of the connecting portions in the third direction, and/or the lengths of the first wiring portions and the second wiring portions in the second direction are longer than the lengths of the first wiring portions and the second wiring portions in the third direction. With this configuration, an inner diameter of the coil is reduced in the multilayer coil component. In the multilayer coil component, when the inner diameter of the coil is reduced, its inductance value is reduced. Thus, the inductance value can be reduced without changing a magnetic path length of the coil. In the multilayer coil component, since the inner diameter of the coil is reduced without changing the magnetic path length of the coil, a decrease in the Q factor can be inhibited. Accordingly, in the multilayer coil component, it is possible to inhibit a decrease in the Q factor while reducing the inductance value. As a result, desired characteristics can be obtained in the multilayer coil component.

In one embodiment, the lengths of the connecting portions in the first direction may be longer than the lengths of the first wiring portions and the second wiring portions in the second direction. In this configuration, the lengths of the first wiring portions and the second wiring portions in the second direction are set to be smaller than the lengths of the connecting portions in the first direction, and the inner diameter of the coil is set mainly by the lengths of the connecting portions. Thus, in the multilayer coil component, since the lengths of the first wiring portions and the second wiring portions in the second direction are not lengthened, distances between the second wiring portions and the terminal electrodes can be increased. Thus, stray capacitance (parasitic capacitance) formed between the second wiring portions and the terminal electrodes can be reduced. For that reason, in the multilayer coil component, it is possible to inhibit a decrease in self-resonant frequency (SRF) and a decrease in Q factor of coil characteristics.

In one embodiment, lengths of the connecting conductors in the second direction may be longer than lengths of the terminal electrodes in the second direction. In this configuration, distances between the coil and the terminal electrodes can be increased. For that reason, in the multilayer coil component, stray capacitance formed between the coil and the terminal electrodes can be reduced. For that reason, in the multilayer coil component, it is possible to inhibit a decrease in the self-resonant frequency and a decrease in the Q factor of the coil characteristics.

In one embodiment, the lengths of the connecting conductors in the second direction may be longer than the lengths of each of the first wiring portions and the second wiring portions in the second direction. In this configuration, the distances between the coil and the terminal electrodes can be increased. For that reason, in the multilayer coil component, the stray capacitance formed between the coil and the terminal electrodes can be reduced. For that reason, in the multilayer coil component, it is possible to inhibit a decrease in the self-resonant frequency and a decrease in the Q factor in the coil characteristics.

In one embodiment, cross-sections of the connecting portions in a plane orthogonal to the second direction may have rectangular shapes of which a length in the first direction is longer than a length in the third direction when viewed in the second direction. In this configuration, the lengths of the connecting portions in the first direction can be longer than the lengths of the connecting portions in the third direction.

In one embodiment, the pair of terminal electrodes may be disposed on the mounting surface of the element body. In this configuration, since the terminal electrodes are not disposed on the end surfaces of the element body, the connecting portions can be disposed closer to the end surfaces (positions near the end surfaces). Thus, since the lengths of the connecting portions in the first direction and distances between the connecting portions in the first direction (corresponding to the inner diameter of the coil) can be increased, it is possible to improve a degree of freedom in designing the L value.

A method for adjusting characteristics of a multilayer coil component according to one aspect of the present disclosure is a method for adjusting characteristics of a multilayer coil component including: an element body that includes a pair of end surfaces opposite each other in a first direction, a mounting surface and a main surface opposite each other in a second direction, and a pair of side surfaces opposite each other in a third direction; a pair of terminal electrodes disposed on the element body; and a coil that is disposed in the element body, is electrically connected to the pair of terminal electrodes, has a coil axis extending in the third direction, and includes first wiring portions disposed on the main surface side, second wiring portions disposed on the mounting surface side, and connecting portions extending in the second direction and connecting the first wiring portions to the second wiring portions; and connecting conductors connecting each of one end portion and another end portion of the coil to one of the pair of terminal electrodes, the method comprising making lengths of the connecting portions in the first direction longer than lengths of the connecting portions in the third direction, and/or lengths of the first wiring portions and the second wiring portions in the second direction longer than lengths of the first wiring portions and the second wiring portions in the third direction.

In the method for adjusting characteristics of a multilayer coil component according to one aspect of the present disclosure, the lengths of the connecting portions in the first direction are longer than the lengths of the connecting portions in the third direction, and/or the lengths of the first wiring portions and the second wiring portions in the second direction are longer than the lengths of the first wiring portions and the second wiring portions in the third direction. With this method, an inner diameter of the coil in the multilayer coil component is reduced. When the inner diameter of the coil in the multilayer coil component is reduced, its inductance value is reduced. In this way, the method for adjusting characteristics of a multilayer coil component can reduce the inductance value without changing the magnetic path length of the coil. In the method for adjusting characteristics of a multilayer coil component, since the inner diameter of the coil is reduced without changing the magnetic path length of the coil, a decrease in the Q factor can be inhibited. Accordingly, in the method for adjusting characteristics of a multilayer coil component, it is possible to inhibit a decrease in the Q factor while reducing the inductance value. As a result, in the method for adjusting characteristics of a multilayer coil component, desired characteristics can be obtained.

According to one aspect of the present disclosure, desired characteristics can be obtained.

### BRIEF DESCRIPTION OF THE DRAWINGS

FIG. 1 is a perspective view of a multilayer coil component according to one embodiment.

FIG. 2 is a side view of the multilayer coil component.

FIG. 3 is an end view of the multilayer coil component.

FIG. 4 is a diagram of the multilayer coil component viewed from a mounting surface side.

### DETAILED DESCRIPTION

A preferred embodiment of the present disclosure will be described in detail below with reference to the accompanying drawings. Also, in the description of the drawings, the same or corresponding elements will be denoted by the same reference numerals, and repeated description thereof will be omitted.

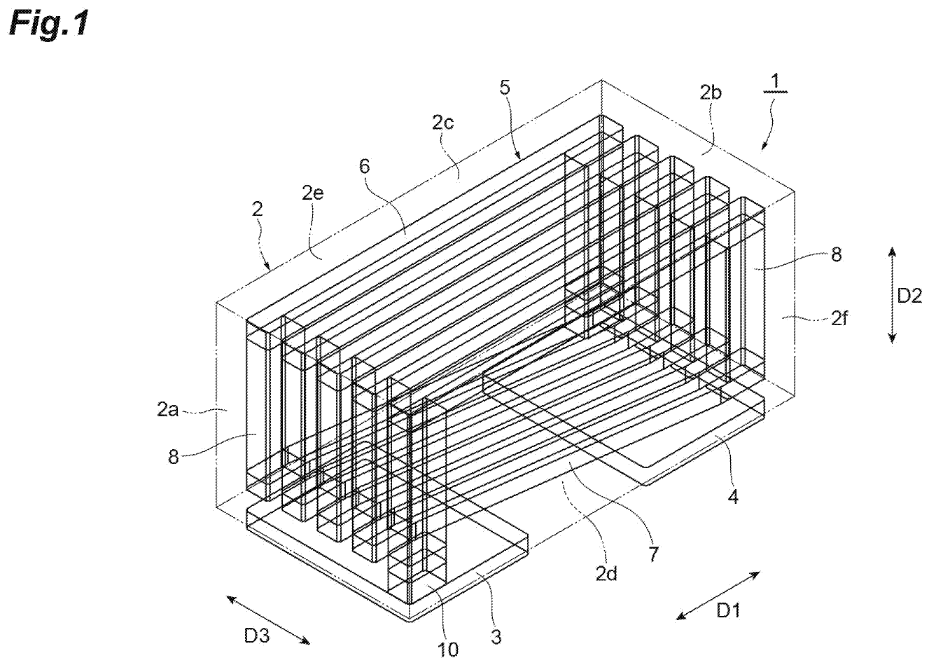

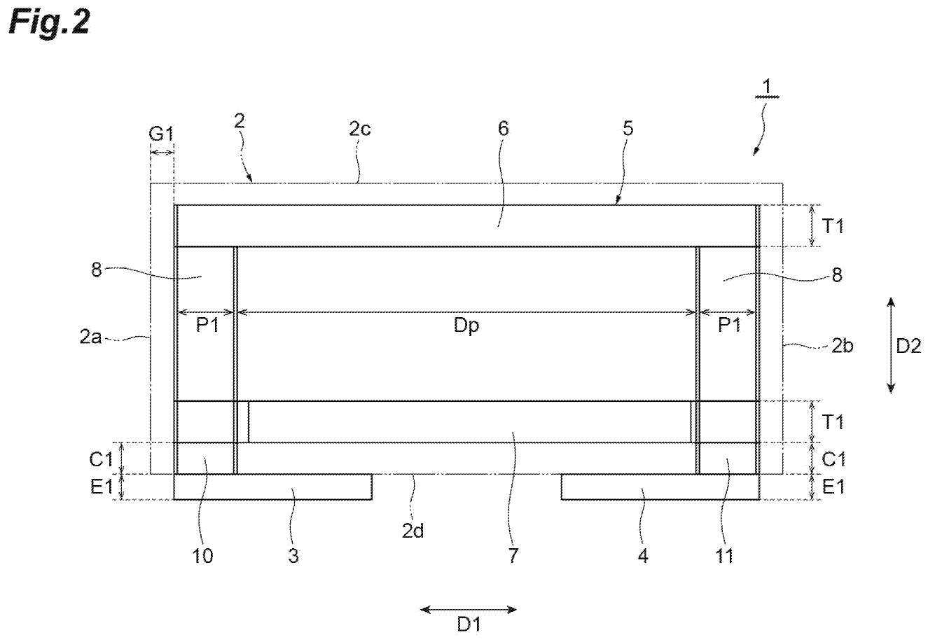

A multilayer coil component according to the present embodiment will be described with reference to FIG. 1. FIG. 1 is a perspective view of a multilayer coil component according to one embodiment. As shown in FIG. 1, the multilayer coil component 1 includes an element body 2, a first terminal electrode 3, a second terminal electrode 4, a coil 5, a first connecting conductor 10, and a second connecting conductor 11 (see FIG. 2). In FIG. 1, for convenience of explanation, the element body 2 is indicated by a two-dot chain line, and the coil 5 is shown transparently. Also, in FIGS. 2 to 4, for convenience of explanation, the coil 5 is shown transparently, and the first terminal electrode 3 and the second terminal electrode 4 are shown by dashed lines.

The element body 2 has a rectangular parallelepiped shape. The rectangular parallelepiped shape may be a rectangular parallelepiped shape with chamfered corner portions and edge portions or a rectangular parallelepiped shape with rounded corner portions and edge portions. The element body 2 has, as outer surfaces, a pair of end surfaces 2a and 2b, a pair of main surfaces 2c and 2d, and a pair of side surfaces 2e and 2f. The end surfaces 2a and 2b are opposite each other. The main surfaces 2c and 2d are opposite each other. The side surfaces 2e and 2f are opposite each other. Hereinafter, a direction in which the end surfaces 2a and 2b are opposite each other will be defined as a first direction D1, a direction in which the main surfaces 2c and 2d are opposite each other will be defined as a second direction D2, and a direction in which the side surfaces 2e and 2f are opposite each other will be defined as a third direction D3. The first direction D1, the second direction D2, and the third direction D3 are substantially orthogonal to each other.

The end surfaces 2a and 2b extend in the second direction D2 to connect the main surfaces 2c and 2d to each other. The end surfaces 2a and 2b also extend in the third direction D3 to connect the side surfaces 2e and 2f to each other. The main surfaces 2c and 2d extend in the first direction D1 to connect the end surfaces 2a and 2b to each other. The main surfaces 2c and 2d also extend in the third direction D3 to connect the side surfaces 2e and 2f to each other. The side surfaces 2e and 2f extend in the first direction D1 to connect the end surfaces 2a and 2b to each other. The side surfaces 2e and 2f also extend in the second direction D2 to connect the main surfaces 2c and 2d to each other.

The main surface 2d is a mounting surface and, for example, is a surface that faces another electronic device (not shown) (for example, a circuit board or a multilayer electronic component) when the multilayer coil component 1 is mounted on the other electronic device. The end surfaces 2a and 2b are surfaces continuous from the mounting surface (that is, the main surface 2d).

A length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, the end surfaces 2a and 2b, the main surfaces 2c and 2d, and side surfaces 2e and 2f have rectangular shapes. The length of the element body 2 in the second direction D2 may be equal to the length of the element body 2 in the third direction D3, or may be longer than the length of the element body 2 in the third direction D3.

Also, in the present embodiment, “equal” may be, in addition to being equal, equal to a value including a slight difference or a manufacturing error within a preset range. For example, when a plurality of values are within ±5% of the mean of the plurality of values, they are defined as being equal.

The element body 2 is formed by laminating a plurality of element body layers (not shown) in the second direction D2. That is, the laminating direction in the element body 2 is the second direction D2. In the actual element body 2, the plurality of element body layers may be integrated to such an extent that boundaries between the layers are invisible, or may be integrated such that the boundaries between the layers are visible.

The element body layer is a resin layer. Materials of the element body layer include at least one selected from, for example, a liquid crystal polymer, a polyimide resin, crystalline polystyrene, an epoxy-based resin, an acryl-based resin, a bismaleimide-based resin, and a fluorine-based resin. The body layer contains a filler. The filler is, for example, an inorganic filler. As the inorganic filler, for example, silica can be exemplified. Also, the element body layer may not contain the filler.

Also, the element body layer may be configured to contain a magnetic material. The magnetic material of the element body layer includes, for example, a Ni—Cu—Zn-based ferrite material, a Ni—Cu—Zn—Mg-based ferrite material, or a Ni—Cu-based ferrite material. The magnetic material of the element body layer may contain, for example, an Fe alloy. The element body layer may contain, for example, a non-magnetic material. The non-magnetic material of the element body layer includes, for example, a glass-ceramic material or a dielectric material.

Each of the first terminal electrode 3 and the second terminal electrode 4 is provided on the element body 2. Each of the first terminal electrode 3 and the second terminal electrode 4 is disposed on the main surface 2d of the element body 2. The first terminal electrode 3 and the second terminal electrode 4 are provided on the element body 2 to be separated from each other in the first direction D1. Specifically, the first terminal electrode 3 is disposed on the end surface 2a side of the element body 2. The second terminal electrode 4 is disposed on the end surface 2b side of the element body 2.

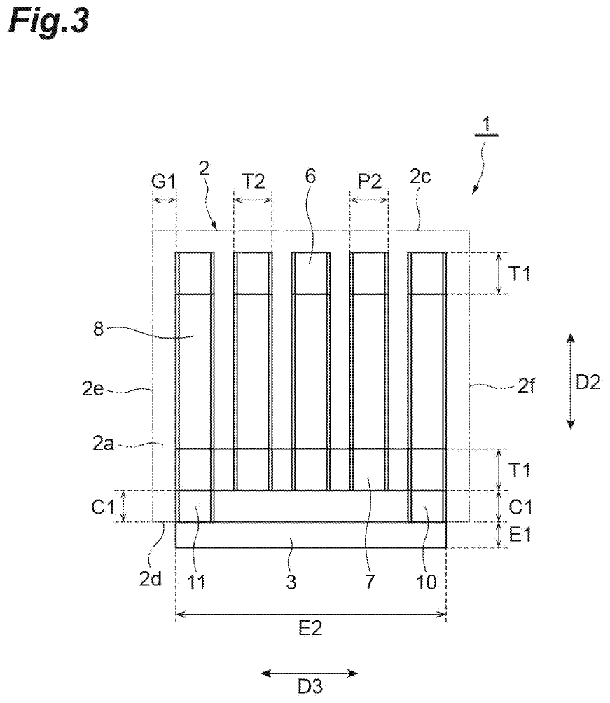

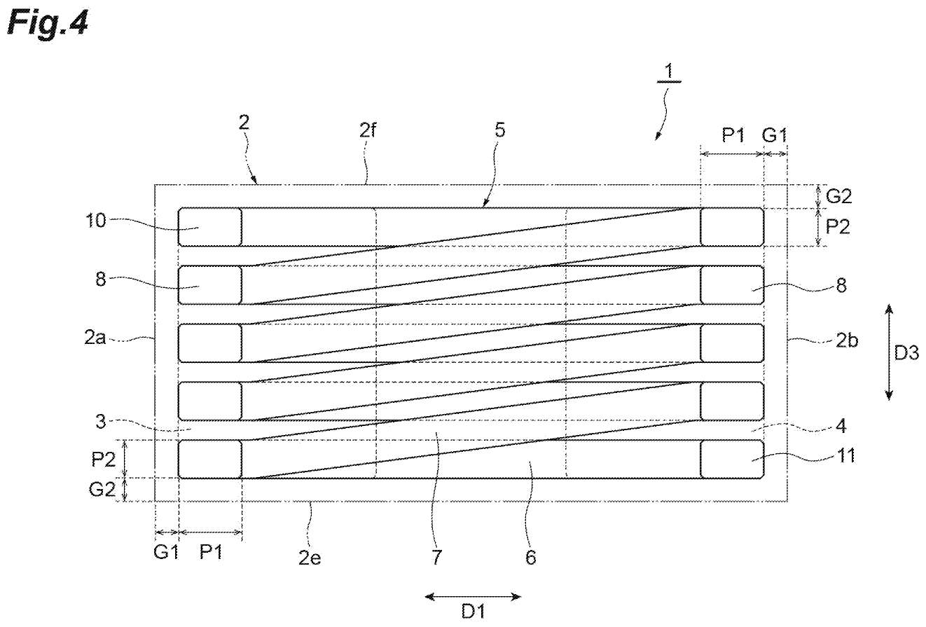

As shown in FIG. 4, each of the first terminal electrode 3 and the second terminal electrode 4 has a rectangular shape (quadrangular shape). Each of the first terminal electrode 3 and the second terminal electrode 4 is disposed such that each side thereof extends in the first direction D1 or the third direction D3. As shown in FIGS. 2 and 3, the first terminal electrode 3 and the second terminal electrode 4 protrude from the main surface 2d. That is, in the present embodiment, surfaces of each of the first terminal electrode 3 and the second terminal electrode 4 are not flush with the main surface 2d. The first terminal electrode 3 and the second terminal electrode 4 are made of a conductive material (for example, Cu).

Each of the first terminal electrode 3 and the second terminal electrode 4 may be provided with a plating layer (not shown) containing, for example, Ni, Sn, Au, or the like by electrolytic plating or electroless plating. The plating layer may have, for example, a Ni plating film that contains Ni and covers the first terminal electrode 3 and the second terminal electrode 4, and an Au plating film that contains Au and covers the Ni plating film. The plating layer provided on each of the first terminal electrode 3 and the second terminal electrode 4 may protrude from the main surface 2d.

As shown in FIGS. 1 to 4, the coil 5 is disposed in the element body 2. The coil 5 has a plurality of first wiring portions 6, a plurality of second wiring portions 7, and a plurality of pillar portions (connecting portions) 8. The coil 5 is configured by electrically connecting the first wiring portions 6, the second wiring portions 7, and the pillar portions 8 to each other. A coil axis of the coil 5 is provided in the third direction D3. The plurality of first wiring portions 6, the plurality of second wiring portions 7, and the plurality of pillar portions 8 are made of a conductive material (for example, Cu). The first wiring portions 6, the second wiring portions 7, and the pillar portions 8 are disposed to be separated from the end surfaces 2a and 2b, the main surfaces 2c and 2d, and the side surfaces 2e and 2f.

Each of the first wiring portions 6 is disposed on the main surface 2c side of the element body 2. Each of the first wiring portions 6 extends in the first direction D1. Each of the first wiring portions 6 connects two pillar portions 8 to each other. Each of the first wiring portions 6 spans over two pillar portions 8. One end portions of the first wiring portions 6 in an extending direction thereof (end portions on the end surface 2a side) are connected to one end portions of the pillar portions 8 (end portions on the main surface 2c side). The other end portions of the first wiring portions 6 in the extending direction (end portions on the end surface 2b side) are connected to one end portions of the pillar portions 8. Cross-sections of the first wiring portions 6 have rectangular shapes. The first wiring portions 6 have prism shapes.

Each of the second wiring portions 7 is disposed on the main surface 2d (mounting surface) side of the element body 2. Each of the second wiring portions 7 extends in the first direction D1. Each of the second wiring portions 7 connects two pillar portions 8 to each other. Each of the second wiring portions 7 spans over two pillar portions 8. One end portions of the second wiring portions 7 in an extending direction thereof (end portions on the end surface 2a side) are connected to the other end portions of the pillar portions 8 (end portions on the side of the main surface 2d). The other end portions of the second wiring portions 7 in an extending direction thereof (end portions on the end surface 2b side) are connected to the other end portions of the pillar portions 8. The number of the plurality of second wiring portions 7 is one less than that of the plurality of first wiring portions 6. That is, in a case in which the number of the first wiring portions 6 is n, the number of the second wiring portions 7 is n−1. Cross-sections of the second wiring portions 7 have rectangular shapes. The second wiring portions 7 have prism shapes.

The pillar portions 8 are disposed on the end surface 2a side and the end surface 2b side of the element body 2. Each of the pillar portions 8 extends in the second direction D2. The pillar portions 8 connect the first wiring portions 6 to the second wiring portions 7. One end portions of the pillar portions 8 are connected to one end portions and the other end portions of the first wiring portions 6. The other end portions of the pillar portions 8 are connected to one end portions and the other end portions of the second wiring portions 7. Cross-sections of the pillar portions 8 along a plane orthogonal to the second direction D2 have rectangular shapes of which lengths in the first direction D1 are longer than lengths in the third direction D3 when viewed in the second direction D2. The pillar portions 8 have prism shapes.

The first connecting conductor 10 connects the first terminal electrode 3 to one end portion of the coil 5. The first connecting conductor is connected to the other end portion of the pillar portion 8 of the coil 5. The first connecting conductor 10 has a prism shape. The first connecting conductor 10 is made of a conductive material (for example, Cu). The second connecting conductor 11 connects the second terminal electrode 4 to the other end portion of the coil 5. The second connecting conductor 11 is connected to the other end portion of the pillar portion 8 of the coil 5. The second connecting conductor 11 has a prism shape. The second connecting conductor 11 is made of a conductive material (for example, Cu).

Next, dimensions of each portion of the multilayer coil component 1 will be described. As shown in FIG. 2 or 3, a length P1 of the pillar portion 8 of the coil 5 in the first direction D1 is longer than a length P2 in the third direction D3 (P1>P2). That is, a width of the pillar portion 8 in the first direction D1 is greater than a width of the pillar portion 8 in the third direction D3. The length P1 of the pillar portion 8 in the first direction D1 is longer than a length T1 of each of the first wiring portion 6 and the second wiring portion 7 in the second direction D2 (P1>T1).

The length T1 of each of the first wiring portion 6 and the second wiring portion 7 in the second direction D2 is longer than a length T2 of each of the first wiring portion 6 and the second wiring portion 7 in the third direction D3 (T1>T2). The length T2 of each of the first wiring portion 6 and the second wiring portion 7 in the third direction D3 is equal to the length P2 of the pillar portion 8 in the third direction D3.

As shown in FIG. 3, lengths (thicknesses) C1 of the first connecting conductor 10 and the second connecting conductor 11 in the second direction D2 are longer (thicker) than a length (thickness) E1 of each of the first terminal electrode 3 and the second terminal electrode 4 in the second direction D2 (C1>E1). The lengths (thicknesses) C1 of the first connecting conductor 10 and the second connecting conductor 11 in the second direction D2 are longer than the length T1 of each of the first wiring portion 6 and the second wiring portion 7 in the second direction D2 (C1>T1). As shown in FIG. 2, the lengths of the first connecting conductor 10 and the second connecting conductor 11 in the third direction D3 are equal to the length P2 of the pillar portion 8 in the third direction D3 and the length T2 of each of the first wiring portion 6 and the second wiring portion 7 in the third direction D3.

In the present embodiment, in the multilayer coil component 1, the coil 5 is disposed in the element body 2 such that a magnetic path length of the coil 5 is maximized. In this configuration, as shown in FIGS. 2 to 4, distances G1 between the end surfaces 2a and 2b of the element body 2 and the pillar portions 8 are equal to distances G2 between the pillar portions 8 located closest to the side surfaces 2e and 2f and the side surfaces 2e and 2f (G1=G2). A distance between a surface of the pillar portion 8 on the side surface 2e side located closest to the side surface 2e and a surface of the pillar portion 8 on the side surface 2f side located closest to the side surface 2f is equal to lengths (widths) E2 of the first terminal electrode 3 and the second terminal electrode 4 in the third direction D3.

The multilayer coil component 1 can be manufactured, for example, as follows. The element body 2 can be formed by laminating sheets constituting the element body layers. The coil 5 (the first wiring portions 6, the second wiring portions 7, and the pillar portions 8), the first connecting conductor 10, and the second connecting conductor 11 can be manufactured using a photolithography method. The “photolithography method” is not limited by a type of mask, or the like as long as it processes a desired pattern by exposing and developing a processing target layer containing a photosensitive material.

In order to adjust coil characteristics of the multilayer coil component 1, dimensions of each portion of the multilayer coil component 1 are set as described above. That is, in a method for adjusting characteristics of the multilayer coil component 1, the length P1 of the pillar portion 8 of the coil 5 in the first direction D1 is set to be longer than the length P2 in the third direction D3 (P1>P2). Thus, as shown in FIG. 2, an inner diameter Dp of the coil 5 (a distance between the pillar portions 8 in the first direction D1) can be reduced. For that reason, an inductance value of the multilayer coil component 1 can be reduced.

As described above, in the multilayer coil component 1 according to the present embodiment, the length P1 of the pillar portion 8 in the first direction D1 is longer than the length P2 of the pillar portion 8 in the third direction D3. With this configuration, in the multilayer coil component 1, the inner diameter Dp of the coil 5 is reduced. In the multilayer coil component 1, when the inner diameter Dp of the coil 5 is reduced, the inductance value is reduced. In this way, the inductance value can be reduced without changing the magnetic path length of the coil 5. In the multilayer coil component 1, since the inner diameter Dp of the coil 5 is reduced without changing the magnetic path length of the coil 5, a decrease in the quality factor (Q factor) can be inhibited. Accordingly, in the multilayer coil component 1, it is possible to inhibit a decrease in the Q factor while reducing the inductance value. As a result, the multilayer coil component 1 can obtain desired characteristics.

In the multilayer coil component 1 according to the present embodiment, the coil 5 is disposed in the element body 2 such that the magnetic path length of the coil 5 is maximized. When the coil 5 is disposed in the element body 2 to have the maximum magnetic path length in this way, it is difficult to increase the magnetic path length of the coil 5 in order to reduce the inductance value due to space constraints within the element body 2, for example. In the multilayer coil component 1, the inductance value can be reduced without changing the magnetic path length of the coil 5. For that reason, the multilayer coil component 1 is particularly effective in adjusting (reducing) the inductance value in the case in which the coil 5 has the maximum magnetic path length.

Also, in the multilayer coil component 1, the length P1 of the pillar portion 8 of the coil 5 in the first direction D1 is longer than the length P2 in the third direction D3 (P1>P2). The cross-section of the pillar portion 8 along the plane orthogonal to the second direction D2 has the rectangular shape of which the length in the first direction D1 is longer than the length in the third direction D3 when viewed in the second direction D2. Thus, in the multilayer coil component 1, the pillar portion 8 can be made thicker than when the length P1 and the length P2 of the pillar portion 8 are equal (P1=P2). For that reason, occurrence of disconnection in the pillar portion 8 can be inhibited.

In the multilayer coil component 1 according to the present embodiment, the length P1 of the pillar portion 8 in the first direction D1 may be longer than the lengths of the first wiring portion 6 and the second wiring portion 7 in the second direction. In this configuration, the lengths T1 of the first wiring portion 6 and the second wiring portion 7 in the second direction D2 are set to be smaller than the length P1 of the pillar portion 8 in the first direction D1, and the inner diameter Dp of the coil 5 is mainly set by the length P1 of the pillar portion 8. Thus, in the multilayer coil component 1, the lengths T1 of the first wiring portion 6 and the second wiring portion 7 in the second direction D2 are not increased, it is possible to increase the distances between the second wiring portion 7, the first terminal electrode 3, and the second terminal electrode 4 (the lengths C1 of the first connecting conductor 10 and the second connecting conductor 11 in the second direction D2). Thus, stray capacitance (parasitic capacitance) formed between the second wiring portion 7, the first terminal electrode 3, and the second terminal electrode 4 can be reduced. For that reason, in the multilayer coil component 1, it is possible to inhibit a decrease in the self-resonant frequency (SRF) and a decrease in the Q factor of the characteristics of the coil 5. In addition, the inner diameter Dp of the coil 5 is larger in the first direction D1 than in the second direction D2. For that reason, in a configuration in which the length P1 of the pillar portion 8 in the first direction D1 is increased, fine adjustment of the inductance value is possible.

In the multilayer coil component 1 according to the present embodiment, the lengths C1 of the first connecting conductor 10 and the second connecting conductor 11 in the second direction D2 are longer than the lengths E1 of the first terminal electrode 3 and the second terminal electrode 4 in the second direction D2 (C1>E1). In this configuration, the distances between the coil 5, the first terminal electrode 3, and the second terminal electrode 4 can be increased. For that reason, in the multilayer coil component 1, stray capacitance formed between the coil 5, the first terminal electrode 3, and the second terminal electrode 4 can be reduced. For that reason, in the multilayer coil component 1, it is possible to inhibit a decrease in the self-resonant frequency and a decrease in the Q factor of the characteristics of the coil 5.

In the multilayer coil component 1 according to the present embodiment, the lengths (C1) of the first connecting conductor 10 and the second connecting conductor 11 in the second direction D2 are longer than the length T1 of each of the first wiring portion 6 and the second wiring portion 7 in the second direction D2 (C1>T1). In this configuration, the distances between the coil 5, the first terminal electrode 3, and the second terminal electrode 4 can be increased. For that reason, in the multilayer coil component 1, the stray capacitance formed between the coil 5, the first terminal electrode 3, and the second terminal electrode 4 can be reduced. For that reason, in the multilayer coil component 1, it is possible to inhibit a decrease in the self-resonant frequency and a decrease in the Q factor of the characteristics of the coil 5.

In the multilayer coil component 1 according to the present embodiment, the cross-section of the pillar portion 8 along the plane orthogonal to the second direction D2 has the rectangular shape of which the length P1 in the first direction D1 being longer than the length P2 in the third direction D3 when viewed in the second direction D2. In this configuration, the length P1 of the pillar portion 8 in the first direction D1 can be made longer than the length P2 of the pillar portion 8 in the third direction D3.

In the multilayer coil component 1 according to the present embodiment, each of the first terminal electrode 3 and the second terminal electrode 4 is disposed on the main surface 2d of the element body 2. In this configuration, since the first terminal electrode 3 and the second terminal electrode 4 are not disposed on the end surfaces 2a and 2b of the element body, the pillar portion 8 can be disposed closer to the end surfaces 2a and 2b (positions near the end surfaces 2a and 2b). Thus, since the length P1 of the pillar portion 8 in the first direction D1 and the distance between the pillar portions 8 in the first direction D1 (corresponding to the inner diameter Dp of the coil 5) can be increased, a degree of freedom in designing the L value can be improved.

Although the embodiment of the present disclosure has been described above, the present disclosure is not necessarily limited to the above-described embodiment, and various modifications can be made without departing from the scope of the present disclosure.

In the above embodiment, an aspect in which the length T1 of each of the first wiring portion 6 and the second wiring portion 7 in the second direction D2 is longer than the length T2 of each of the first wiring portion 6 and the second wiring portion 7 in the third direction D3 (T1>T2) has been described as one example. However, the length T1 of each of the first wiring portion 6 and the second wiring portion 7 in the second direction D2 may be equal to the length T2 of each of the first wiring portion 6 and the second wiring portion 7 in the third direction D3 (T1=T2). In addition, the length T1 of each of the first wiring portion 6 and the second wiring portion 7 in the second direction D2 may be shorter than the length T2 of each of the first wiring portion 6 and the second wiring portion 7 in the third direction D3 (T1<T2).

In the above embodiment, an aspect in which the length P1 of the pillar portion 8 of the coil 5 in the first direction D1 is longer than the length P2 in the third direction D3 (P1>P2) has been described as one example. However, the length P1 of the pillar portion 8 of the coil 5 in the first direction D1 may be equal to the length P2 in the third direction D3 (P1=P2). In this configuration, the length T1 of each of the first wiring portion 6 and the second wiring portion 7 in the second direction D2 is set to be longer than the length T2 of each of the first wiring portion 6 and the second wiring portion 7 in the third direction D3 (T1>T2).

With this configuration, in the multilayer coil component 1, the inner diameter of the coil 5 is reduced. In the multilayer coil component 1, when the inner diameter of the coil 5 is reduced, the inductance value is reduced. In this way, the inductance value can be reduced without changing the magnetic path length of the coil 5. In the multilayer coil component 1, since the inner diameter Dp of the coil 5 is reduced without changing the magnetic path length of the coil 5, a decrease in the quality factor (Q factor) can be inhibited. Accordingly, in the multilayer coil component 1, it is possible to inhibit a decrease in the Q value while decreasing the inductance value. As a result, the multilayer coil component 1 can obtain desired characteristics.

Also, in the multilayer coil component 1, the length T1 of each of the first wiring portion 6 and the second wiring portion 7 in the second direction D2 is longer than the length T2 of each of the first wiring portion 6 and the second wiring portion 7 in the third direction D3 (T1>T2). Thus, in the multilayer coil component 1, the first wiring portion 6 and the second wiring portion 7 are thickened. For that reason, occurrence of disconnection in the first wiring portion 6 and the second wiring portion 7 can be inhibited. Further, since the first wiring portion 6 and the second wiring portion 7 are thickened, electrical resistivity of DC resistance of the first wiring portion 6 and the second wiring portion 7 can be reduced. Thus, improvement of the Q factor can be achieved.

In the above embodiment, an aspect in which the first terminal electrode 3 and the second terminal electrode 4 protrude from the main surface 2d has been described as one example. However, the first terminal electrode 3 and the second terminal electrode 4 may be embedded within the element body 2. That is, the first terminal electrode 3 and the second terminal electrode 4 may be provided to be substantially flush with the main surface 2d. In this configuration, the plating layers provided on each of the first terminal electrode 3 and the second terminal electrode 4 may protrude from the main surface 2d.

In the above embodiment, an aspect in which each of the first terminal electrode 3 and the second terminal electrode 4 is disposed on the main surface 2d of the element body 2 has been described as one example. However, the first terminal electrode 3 may be disposed on the end surface 2a. The second terminal electrode 4 may be disposed on the end surface 2b. That is, the first terminal electrode 3 and the second terminal electrode 4 may have L shapes when viewed in the third direction D3.

In the above embodiment, an aspect in which the cross-sections of the first wiring portion 6, the second wiring portion 7, and the pillar portion 8 have rectangular shapes has been described as one example. However, the cross-sections of the first wiring portion 6, the second wiring portion 7, and the pillar portion 8 may have other shapes, such as elliptical shapes.

What is claimed is:

1. A multilayer coil component comprising:
an element body that includes a pair of end surfaces opposite each other in a first direction, a mounting surface and a main surface opposite each other in a second direction, and a pair of side surfaces opposite each other in a third direction;
a pair of terminal electrodes disposed on the element body;
a coil that is disposed in the element body, is electrically connected to the pair of terminal electrodes, and has a coil axis extending in the third direction; and
connecting conductors connecting each of one end portion and another end portion of the coil to one of the pair of terminal electrodes,
wherein the coil includes first wiring portions disposed on the main surface side, second wiring portions disposed on the mounting surface side, and connecting portions that extend in the second direction and connect the first wiring portions to the second wiring portions, and lengths of the connecting portions in the first direction are longer than lengths of the connecting portions in the third direction, and/or lengths of the first wiring portions and the second wiring portions in the second direction are longer than lengths of the first wiring portions and the second wiring portions in the third direction.

2. The multilayer coil component according to claim 1, wherein the lengths of the connecting portions in the first direction are longer than the lengths of the first wiring portions and the second wiring portions in the second direction.

3. The multilayer coil component according to claim 1, wherein lengths of the connecting conductors in the second direction are longer than lengths of the terminal electrodes in the second direction.

4. The multilayer coil component according to claim 1, wherein the lengths of the connecting conductors in the second direction are longer than the lengths of each of the first wiring portions and the second wiring portions in the second direction.

5. The multilayer coil component according to claim 1, wherein cross-sections of the connecting portions in a plane orthogonal to the second direction have rectangular shapes of which a length in the first direction is longer than a length in the third direction when viewed in the second direction.

6. The multilayer coil component according to claim 1, wherein the pair of terminal electrodes are disposed on the mounting surface of the element body.

7. A method for adjusting characteristics of a multilayer coil component including:
an element body that includes a pair of end surfaces opposite each other in a first direction, a mounting surface and a main surface opposite each other in a second direction, and a pair of side surfaces opposite each other in a third direction;
a pair of terminal electrodes disposed on the element body;
a coil that is disposed in the element body, is electrically connected to the pair of terminal electrodes, has a coil axis extending in the third direction, and includes first wiring portions disposed on the main surface side, second wiring portions disposed on the mounting surface side, and connecting portions extending in the second direction and connecting the first wiring portions to the second wiring portions; and
connecting conductors connecting each of one end portion and another end portion of the coil to one of the pair of terminal electrodes,
the method comprising making lengths of the connecting portions in the first direction longer than lengths of the connecting portions in the third direction, and/or lengths of the first wiring portions and the second wiring portions in the second direction longer than lengths of the first wiring portions and the second wiring portions in the third direction.
